(19) United States
(12) Patent Application Publication
(10) Pub. No.: US 2026/0109833 A1
(43) Pub. Date: Apr. 23, 2026

(54) METHOD OF RECOVERING FLAME RETARDANT FROM STYRENIC POLYMER WASTE

(71) Applicant: POLYSTYVERT INC., ANJOU (CA)

(72) Inventors: Roland CÔTÉ, St-Antoine-sur-Richelieu (CA); Jean-Mathieu PIN, Anjou (CA)

(73) Assignee: POLYSTYVERT INC., ANJOU (CA)

(21) Appl. No.: 19/485,653

(22) PCT Filed: May 16, 2024
(86) PCT No.: PCT/CA2024/050657

§ 371 Date: Nov. 18, 2025

Related U.S. Application Data
(60) Provisional application No. 63/467,528, filed on May 18, 2023.

(51) Int. Cl. C08J 11/08

(52) U.S. Cl. CPC C08J 11/08; C08J 2325/06

(57) ABSTRACT

The present disclosure relates to methods of recovering flame retardant from a styrenic polymer waste.

### CROSS-REFERENCE TO RELATED APPLICATIONS

The present application claims priority from U.S. 63/467,528, filed on May 18, 2023 and that is hereby incorporated by reference in its entirety.

### FIELD

The present disclosure relates to methods of separating flame retardant from styrenic polymer in a styrenic polymer waste. The present disclosure further relates to methods of recovering flame retardant from styrenic polymer waste.

### INTRODUCTION

Post-consumer styrenic polymer waste is routinely recycled to obtain recycle polymer material that can be repurposed. Many post-consumer styrenic waste contains flame retardants of different chemical nature that are difficult to separate from the polymer material. Nevertheless, some of these flame retardants are valuable substances that can be reused or repurposed, while others are harmful to consumer health and may have been banned by relevant authorities.

Therefore, there exists a need to develop methods of separating different flame retardants from styrenic polymer in a styrenic polymer waste.

### SUMMARY

It has been shown herein that taking advantage of the differential solubility of different flame retardants and styrenic polymer in various solvents, flame retardants can be separated and recovered from the styrenic polymer waste.

Accordingly, in one aspect, the present disclosure includes a method of recovering a flame retardant from a styrenic polymer waste, the styrenic polymer comprising the flame retardant and a styrenic polymer, the method comprising
combining the styrenic polymer waste with a first solvent to obtain a soluble portion and an insoluble portion, and
separating the soluble portion and the insoluble portion;
wherein
   either the flame retardant is substantially in the soluble portion and the styrenic polymer is substantially in the insoluble portion; or
   the flame retardant is substantially in the insoluble portion and the styrenic polymer is substantially in the soluble portion.

In some embodiments, the flame retardant is substantially in the soluble portion and the styrenic polymer is substantially in the insoluble portion.

In some embodiments, the method further comprises recovering the flame retardant from the soluble portion by solvent removal. In some embodiments, solvent removal comprises precipitation, crystallization, solvent evaporation and combinations thereof.

In some embodiments, the method further comprises combining the soluble portion with a flame retardant non-solvent to selectively precipitate or crystallise the flame retardant, and recovering the precipitated flame retardant In some embodiments, the recovering of the precipitated flame retardant is carried out by filtration, decantation, and/or centrifugation.

In some embodiments, the method further comprises washing the insoluble portion with one or more further portions of the first solvent after the separating to obtain a wash portion and a washed insoluble potion.

In some embodiments, the method further comprises combining the wash portion and the soluble portion to obtain a combined soluble portion.

In some embodiments, the method further comprises combining the combined soluble portion with a flame retardant non-solvent to selectively precipitate or crystallise the flame retardant, and recovering the precipitated or crystrallised flame retardant. In some embodiments, the recovering of the precipitated flame retardant is carried out by filtration, decantation, and/or centrifugation.

In some embodiments, the flame retardant is selected from HBCD, PBDE, TBBPA, TBPC, Octabromodiphenyl oxide (Octabrom), Decabromodiphenyl oxide (DBDPO), and mixtures thereof.

In some embodiments, the first solvent is a non-solvent for the styrenic polymer, and wherein the first solvent is selected from C₅₋₈ alkanes, C₁₋₅ alkyl alcohol, alkyl esters (e.g. ethyl acetate), alkyl ketones (e.g. methylethyl ketone), and mixtures thereof or the first solvent is a mixture of an benzenic solvent (e.g. selected from p-cymene, ethylbenzene, toluene, and mixtures thereof) and a polar non-protic solvent (e.g. selected from alkyl esters (e.g. ethyl acetate), alkyl ketones (e.g. methylethyl ketone), ethers, N, N,-dialkyl amide (e.g. DMF) and mixtures thereof).

In some embodiments, the first solvent comprises pentane, hexane, heptane, octane, methanol, ethanol, propanol, isopropanol, butanol, methylethylketone, ethyl acetate, DMF, p-cymene, ethylbenzene, toluene, and mixtures thereof.

In some embodiments, the method further comprises washing the insoluble portion with one or more portions of a styrenic polymer non-solvent to obtain a washed insoluble portion. In some embodiments, the washing is carried out at a temperature above a glass transition state temperature (Tg) of the washed insoluble portion.

In some embodiments, the styrenic polymer non-solvent is selected from C₅₋₈ alkanes, C₁₋₅ alkyl alcohol, and mixtures thereof. In some embodiments, the styrenic polymer non-solvent is selected from pentane, hexane, heptane, octane, methanol, ethanol, propanol, isopropanol, butanol, and mixtures thereof.

In some embodiments, the method further comprises drying the washed insoluble portion to recover the styrenic polymer.

In some embodiments, the method further comprises
combining the insoluble portion with a second solvent to obtain a styrenic polymer mixture;
heating the styrenic polymer mixture to a temperature sufficient to dissolve the styrenic polymer to obtain a styrenic polymer solution;
combining the styrenic polymer solution with a styrenic polymer non-solvent to selectively precipitate the styrenic polymer; and
recovering the precipitated styrenic polymer, optionally by filtration, decantation, and/or centrifugation; and
optionally washing the recovered styrenic polymer with one or more further portions of the styrenic polymer non-solvent, and drying the recovered styrenic polymer.

In some embodiments, the second solvent is selected from a first solvent as defined herein, cyclohexane, a mixture of acetone and a benzenic solvent (e.g. p-cymene, toluene, ethylbenzene) and mixtures thereof.

In some embodiments, the combining of the insoluble portion and the second solvent is carried out such that the styrenic polymer is present in the styrenic polymer mixture at about 5 wt % to about 30 wt %.

In some embodiments, the temperature is about room temperature (25° C.) to about 100° C.

In some embodiments, the flame retardant is substantially in the insoluble portion and the styrenic polymer is substantially in the soluble portion.

In some embodiments, the method further comprises drying the insoluble portion to recover the flame retardant.

In some embodiments, the method further comprises washing the insoluble portion with one or more further portions of the first solvent to obtain a wash portion and a washed insoluble portion.

In some embodiments, the method further comprises drying the washed insoluble portion to recover the flame retardant.

In some embodiments, the method further comprises recovering the styrenic polymer by solvent removal. In some embodiments, the solvent removal comprises solvent evaporation, precipitation, and/or crystallisation.

In some embodiments, the first solvent is selected from C₅₋₈ alkanes, C₁₋₅ alkyl alcohol, and mixtures thereof. In some embodiments, the first solvent is selected from pentane, hexane, heptane, octane, methanol, ethanol, propanol, isopropanol, butanol, and mixtures thereof and mixtures thereof.

In some embodiments, the flame retardant is selected from DBDPE, N,N-ethylene bis(tetrabromophthalimide), Tris(tribromoneopentyl)phosphate and mixtures thereof.

In some embodiments, the flame retardant is substantially in the insoluble portion and the styrenic polymer is substantially in the soluble portion, and wherein the flame retardant comprises inorganic flame retardant. In some embodiments, the inorganic flame retardant is selected from Sb₂O₃, ammonium halide, metal hydroxide (e.g. MgOH, aluminum trihydrate), Ca₃(BO₃)₂, inorganic phosphate salts (e.g. ammonium phosphate), and mixtures thereof.

In some embodiments, the method further comprises prior to the separating of the soluble portion and the insoluble portion, combining the soluble portion and the insoluble portion with a third solvent to obtain a microgel comprising a portion of the styrenic polymer in the soluble portion; and
wherein the separating of the soluble portion and the insoluble portion is carried out by centrifugation such that the microgel of the styrenic polymer is present as a suspension in the soluble portion and the insoluble portion is present as a pellet.

In some embodiments, the third solvent is capable of swelling the styrenic polymer or forming a gel with the styrenic polymer.

In some embodiments, the third solvent is selected from p-cymene, toluene, benzene, ethylbenzene, ethyl acetate, acetone, MEK, and mixtures thereof.

In some embodiments, the microgel comprises about 15 wt % to about 25 wt % of the styrenic polymer. In some embodiments, the styrenic polymer is selected from HIPS, ABS, and mixtures thereof. It can be appreciated that HIPS and ABS both contain polybutadiene components (for example elastomer domains of polybutadiene). In some embodiments, the microgel comprises polybutadiene components of the styrenic polymer.

In some embodiments, the method further comprises recovering the pellet to recover the flame retardant, and optionally washing the pellet with one or more further portions of the first solvent.

In some embodiments, the inorganic flame retardant comprises Sb₂O₃.

In some embodiments, the styrenic polymer waste further comprises an inorganic pigment, optionally the inorganic pigment comprises TiO₂, wherein the inorganic pigment is recovered with the inorganic flame retardant, and optionally wherein the method further comprises separating the Sb₂O₃ and the TiO₂, optionally the separating is carried out by selectively solubilizing the Sb₂O₃ in a basic medium, optionally the basic medium comprises an aqueous hydroxide solution (e.g. KOH. NaOH, LiOH).

In some embodiments, the flame retardant further comprises organic flame retardant.

In some embodiments, the organic flame retardant is selected from PBDE, TBBPA, TBPC, Octabromodiphenyl oxide (Octabrom), Decabromodiphenyl oxide (DBDPO), and mixtures thereof.

In some embodiments, the organic flame retardant is selected from DBDPE, N, N-ethylene bis(tetrabromophthalimide), Tris(tribromoneopentyl)phosphate and mixtures thereof.

In some embodiments, the method further comprises separating the inorganic flame retardant from the organic flame retardant.

In some embodiments, the method further comprises purifying the recovered flame retardant.

In some embodiments, the styrenic polymer is selected from ABS, HIPS, atactic polystyrene (PS), SAN, SBS, syndiotactic PS, isotactic PS, Styrene Methyl Methacrylate (SMMA), Methyl methacrylate-acrylonitrile-butadiene-styrene (MABS), Methyl methacrylate-butadiene-styrene (MBS), and mixtures thereof.

Accordingly to another aspect, the present disclosure includes a method of recovering a flame retardant from a polymer waste, the polymer comprising the flame retardant and a polymer, the method comprising
combining the polymer waste with a first solvent to obtain a soluble portion and an insoluble portion, and
separating the soluble portion and the insoluble portion;
wherein
   either the flame retardant is substantially in the soluble portion and the polymer is substantially in the insoluble portion; or
   the flame retardant is substantially in the insoluble portion and the polymer is substantially in the soluble portion.

### DRAWINGS

The embodiments of the disclosure will now be described in greater detail with reference to the attached drawings in which:

FIG. 1 shows a flowchart illustrating an exemplary method 100 of the present disclosure.

FIG. 2 shows a flowchart illustrating an exemplary method 200 of the present disclosure.

FIG. 3 shows a flowchart illustrating an exemplary method 300 of the present disclosure where flame retardant insoluble in the first solvent is recovered and where optional soluble flame retardant may be present in the styrenic polymer waste as well.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should be given the broadest interpretation consistent with the description as a whole.

### DESCRIPTION OF VARIOUS EMBODIMENTS

### I. Definitions

Unless otherwise indicated, the definitions and embodiments described in this and other sections are intended to be applicable to all embodiments and aspects of the present disclosure herein described for which they are suitable as would be understood by a person skilled in the art.

The term “and/or” as used herein means that the listed items are present, or used, individually or in combination. In effect, this term means that “at least one of” or “one or more” of the listed items is used or present.

As used in the present disclosure, the singular forms “a”, “an” and “the” include plural references unless the content clearly dictates otherwise. For example, an embodiment including “a compound” should be understood to present certain aspects with one compound, or two or more additional compounds.

In embodiments comprising an “additional” or “second” component, such as an additional or second solvent, the second component as used herein is chemically different from the other components or first component. A “third” component is different from the other, first, and second components, and further enumerated or “additional” components are similarly different.

As used in this disclosure and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The present description refers to a number of chemical terms and abbreviations used by those skilled in the art. Nevertheless, definitions of selected terms are provided for clarity and consistency.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “styrenic polymer” as used herein means a polymer, for example a homopolymer or a copolymer, where at least one monomer is a styrene-based monomer or a vinyl aromatic monomer. For example, styrenic polymer includes homopolymer of styrene (i.e. polystyrene), and copolymer of styrene with one or more polymerizable monomers. For example, styrenic polymer also includes graft polymers, e.g. a homopolymer or copolymer comprising at least one styrene-based monomer or vinyl aromatic based monomer grafted with a non-styrenic polymer, or a homopolymer or copolymer comprising at least one styrene-based monomer or vinyl aromatic based monomer grafted with one or more other homopolymers or copolymers comprising at least one styrene-based monomer or vinyl aromatic based monomer. The copolymer can be block copolymer.

The term “styrenic polymer waste” as used herein means a waste material that comprises at least one styrenic polymer as described herein and a flame retardant.

The term “non-solvent” for a particular substance as used herein means to a compound or a mixture of compounds in which the substance is substantially insoluble. For example, a styrenic polymer non-solvent refers to a compound or a mixture of compounds in which a styrenic polymer is substantially insoluble. For example, a flame retardant non-solvent refers to a compound or a mixture of compounds in which one or more types of flame retardant are not substantially non-soluble in.

### II. Methods of the Present Disclosure

The present disclosure relates to methods for recovering flame retardants from styrenic polymer waste.

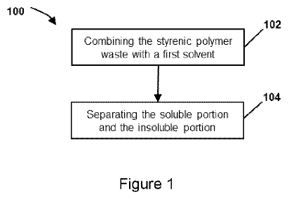

Referring to FIG. 1, shown therein as an example method 100 of the present disclosure. At step 102, the styrenic polymer waste to be recycled is combined with a first solvent. The styrenic polymer waste is partially solubilized. At step 104, the soluble portion and the insoluble portion is separated. The flame retardant is present in either the soluble portion or the insoluble portion and can therefore be recovered.

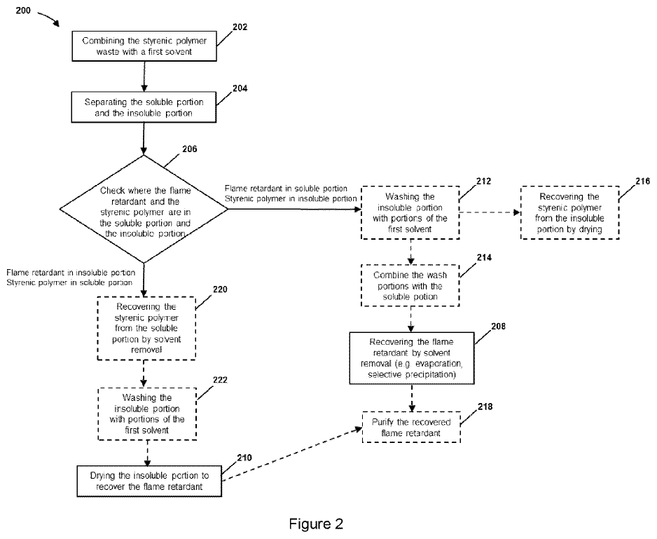

Referring to FIG. 2, shown there is an example method 200 of the present disclosure. At step 202, the styrenic polymer waste to be recycled is combined with a first solvent. The styrenic polymer waste is partially solubilized. At step 204, the soluble portion and the insoluble portion are separated. It is then determined at step 206 whether the flame retardant is in the soluble portion or the insoluble portion. The styrenic polymer is in the other portion.

If the flame retardant is in the soluble portion and the styrenic polymer is in the insoluble portion, the method moves to step 208 where the flame retardant is recovered from the soluble portion by solvent removal. For example, solvent removal can be achieved by means known in the art, including but not limited to evaporation, selective precipitation, and crystallization. Optionally, as shown in step 212, the insoluble portion can be washed with further portions of the first solvent to further extract any residual flame retardant in the insoluble portion. To facilitate the extraction of residual flame retardant, it is possible to combine the insoluble part with an amount of styrenic polymer solvent to swell the styrenic polymer into a gel or paste. The washing of step 212 can be then done at higher temperature above the glass transition temperature (Tg) of the polymer gel or paste to keep the gel/paste more malleable to facilitate extraction of residual flame retardant.

The wash portions of step 212 can be combined with the soluble portion at step 214. The flame retardant can be extracted from the combined soluble portion by solvent removal as described herein.

If the flame retardant is determined to be in the insoluble portion and the styrenic polymer is in the soluble portion, the method moves to step 210 to dry the insoluble portion to recover the flame retardant. Optionally, at step 222, the insoluble portion can be further washed with further portions of the first solvent to remove any residual polymer. The soluble portion containing the styrenic polymer can be used in optional step 220 to recover the styrenic polymer by solvent removal as described herein.

As shown in step 218, once the flame retardant has been removed in steps 208 and 210, the recovered flame retardant can be purified by means known in the art for example by recrystallisation and/or column chromatography.

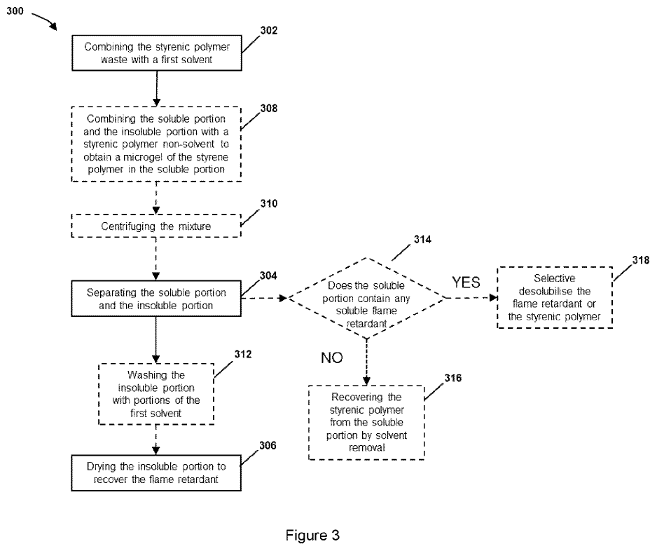

Referring to FIG. 3, shown there is an example method 300 of the present disclosure where the flame retardant is present in the soluble portion and the styrenic polymer is present in the insoluble portion. At step 302, the styrenic polymer waste to be recycled is combined with a first solvent. The styrenic polymer waste is partially solubilized. Optionally, prior to separating the soluble portion and the insoluble portion (304), a styrenic polymer non-solvent is combined with the mixture of the soluble portion and the insoluble portion at step 308 to obtain a microgel comprising a portion of the styrene polymer, with the remainder of the styrenic polymer in the soluble portion. The mixture resulting from step 308 can optionally be centrifuged at step 310, where the microgel remains as a suspension in the soluble portion comprising the styrenic polymer. The insoluble flame retardant deposits at the bottom as a pellet of the centrifugation. The mixture is then separated as shown in step 304.

As shown in step 312, the insoluble portion containing the flame retardant can optionally be washed with further portions of the first solvent to extract any polymer.

The soluble mixture resulting from step 304 can be determined to see whether it contains further soluble flame retardant. If yes, the soluble flame retardant or the polymer can be selectively extracted by for example selectively precipitating either the flame retardant or the polymer (step 318). If not, the styrenic polymer can optionally recovered by solvent removal at step 316.

In one aspect, the present disclosure includes a method of recovering a flame retardant from a styrenic polymer waste, the styrenic polymer comprising the flame retardant and a styrenic polymer, the method comprising
combining the styrenic polymer waste with a first solvent to obtain a soluble portion and an insoluble portion, and
separating the soluble portion and the insoluble portion;
wherein
   either the flame retardant is substantially in the soluble portion and the styrenic polymer is substantially in the insoluble portion; or
   the flame retardant is substantially in the insoluble portion and the styrenic polymer is substantially in the soluble portion.

In some embodiments, the flame retardant is substantially in the soluble portion and the styrenic polymer is substantially in the insoluble portion.

In some embodiments, the method further comprises recovering the flame retardant from the soluble portion by solvent removal. In some embodiments, solvent removal comprises precipitation, crystallization, solvent evaporation and combinations thereof.

In some embodiments, the method further comprises combining the soluble portion with a flame retardant non-solvent to selectively precipitate or crystallise the flame retardant, and recovering the precipitated flame retardant. In some embodiments, the recovering of the precipitated flame retardant is carried out by filtration, decantation, and/or centrifugation.

In some embodiments, the method further comprises washing the insoluble portion with one or more further portions of the first solvent after the separating to obtain a wash portion and a washed insoluble potion.

In some embodiments, the method further comprises combining the wash portion and the soluble portion to obtain a combined soluble portion.

In some embodiments, the method further comprises combining the combined soluble portion with a flame retardant non-solvent to selectively precipitate or crystallise the flame retardant, and recovering the precipitated or crystrallised flame retardant. In some embodiments, the recovering of the precipitated or crystallised flame retardant is carried out by filtration, decantation, and/or centrifugation.

In some embodiments, the flame retardant is selected from HBCD, PBDE, TBBPA, TBPC, Octabromodiphenyl oxide (Octabrom), Decabromodiphenyl oxide (DBDPO), and mixtures thereof.

In some embodiments, the first solvent is a non-solvent for the styrenic polymer, and wherein the first solvent is selected from C₅₋₈ alkanes, C₁₋₅ alkyl alcohol, alkyl esters, alkyl ketones, and mixtures thereof or the first solvent is a mixture of an benzenic solvent (e.g. selected from p-cymene, ethylbenzene, toluene, and mixtures thereof) and a polar non-protic solvent (e.g. selected from alkyl esters (e.g. ethyl acetate), alkyl ketones (e.g. methylethyl ketone), ethers, N,N,-dialkyl amide (e.g. DMF) and mixtures thereof).

In some embodiments, the first solvent comprises pentane, hexane, heptane, octane, methanol, ethanol, propanol, isopropanol, butanol, methylethylketone, ethyl acetate, DMF, ethylacetate, p-cymene, ethylbenzene, toluene, and mixtures thereof.

In some embodiments, the method further comprises washing the insoluble portion with one or more portions of a styrenic polymer non-solvent to obtain a washed insoluble portion. In some embodiments, the washing is carried out at a temperature above a glass transition state temperature (Tg) of the washed insoluble portion.

In some embodiments, the styrenic polymer non-solvent is selected from C₅₋₈ alkanes, C₁₋₅ alkyl alcohol, and mixtures thereof. In some embodiments, the styrenic polymer non-solvent is selected from pentane, hexane, heptane, octane, methanol, ethanol, propanol, isopropanol, butanol, and mixtures thereof.

In some embodiments, the method further comprises drying the washed insoluble portion to recover the styrenic polymer.

In some embodiments, the method further comprises
combining the insoluble portion with a second solvent to obtain a styrenic polymer mixture;
heating the styrenic polymer mixture to a temperature sufficient to dissolve the styrenic polymer to obtain a styrenic polymer solution;
combining the styrenic polymer solution with a styrenic polymer non-solvent to selectively precipitate the styrenic polymer; and
recovering the precipitated styrenic polymer, optionally by filtration, decantation, and/or centrifugation; and
optionally washing the recovered styrenic polymer with one or more further portions of the styrenic polymer non-solvent, and drying the recovered styrenic polymer.

In some embodiments, the second solvent is selected from a first solvent as defined herein, cyclohexane, a mixture of acetone and a benzenic solvent (e.g. p-cymene, toluene, ethylbenzene) and mixtures thereof.

In some embodiments, the combining of the insoluble portion and the second solvent is carried out such that the styrenic polymer is present in the styrenic polymer mixture at about 5 wt % to about 30 wt %.

In some embodiments, the temperature is about room temperature (25° C.) to about 100° C.

In some embodiments, the flame retardant is substantially in the insoluble portion and the styrenic polymer is substantially in the soluble portion.

In some embodiments, the method further comprises drying the insoluble portion to recover the flame retardant.

In some embodiments, the method further comprises washing the insoluble portion with one or more further portions of the first solvent to obtain a wash portion and a washed insoluble portion.

In some embodiments, the method further comprises drying the washed insoluble portion to recover the flame retardant.

In some embodiments, the method further comprises recovering the styrenic polymer by solvent removal. In some embodiments, the solvent removal comprises solvent evaporation, precipitation, and/or crystallisation.

In some embodiments, the first solvent is selected from C₅₋₈ alkanes, C₁₋₅ alkyl alcohol, and mixtures thereof. In some embodiments, the first solvent is selected from pentane, hexane, heptane, octane, methanol, ethanol, propanol, isopropanol, butanol, and mixtures thereof and mixtures thereof.

In some embodiments, the flame retardant is selected from DBDPE, N,N-ethylene bis(tetrabromophthalimide), Tris(tribromoneopentyl)phosphate and mixtures thereof.

In some embodiments, the flame retardant is substantially in the insoluble portion and the styrenic polymer is substantially in the soluble portion, and wherein the flame retardant comprises inorganic flame retardant. In some embodiments, the inorganic flame retardant is selected from Sb₂O₃, ammonium halide, metal hydroxides (e.g. MgOH, aluminum trihydrate), Ca₃(BO₃)₂, inorganic nitrate salts (e.g. ammonium nitrate), inorganic phosphate salts (e.g. ammonium phosphate), inorganic phosphonate salts, and mixtures thereof.

It can be appreciated by a skilled person that inorganic flame retardant especially Sb₂O₃ is used as a synergist with organic flame retardant. When used in combination, the amount of organic flame retardant can be decreased due to the presence of synergist. The methods of the present disclosure therefore allow for the separation and recovery of synergist from styrenic polymer waste.

In some embodiments, the method further comprises prior to the separating of the soluble portion and the insoluble portion, combining the soluble portion and the insoluble portion with a third solvent to obtain a microgel comprising a portion of the styrenic polymer in the soluble portion; and
wherein the separating of the soluble portion and the insoluble portion is carried out by centrifugation such that the microgel of the styrenic polymer is present as a suspension in the soluble portion and the insoluble portion is present as a pellet.

In some embodiments, the third solvent is capable of swelling the styrenic polymer or forming a gel with the styrenic polymer. It can be appreciated that such a solvent would cause a portion of the styrenic polymer or some of the components of the styrenic polymer to swell into a microgel, which has a density similar to that of the soluble portion. Thus, centrifugation of the mixture would allow the microgel to remain in suspension and the sedimentation of the insoluble portion.

In some embodiments, the third solvent is selected from p-cymene, toluene, benzene, ethylbenzene, ethyl acetate, acetone, MEK, and mixtures thereof.

In some embodiments, the microgel comprises about 15 wt % to about 25 wt % of the styrenic polymer. In some embodiments, the styrenic polymer is selected from HIPS, ABS, and mixtures thereof. It can be appreciated that HIPS and ABS both contain polybutadiene components (for example elastomer domains of polybutadiene). In some embodiments, the microgel comprises polybutadiene components of the styrenic polymer.

In some embodiments, the method further comprises recovering the pellet to recover the flame retardant, and optionally washing the pellet with one or more further portions of the first solvent.

In some embodiments, the inorganic flame retardant comprises Sb₂O₃.

In some embodiments, the styrenic polymer waste further comprises an inorganic pigment, optionally the inorganic pigment comprises TiO₂, wherein the inorganic pigment is recovered with the inorganic flame retardant, and optionally wherein the method further comprises separating the Sb₂O₃ and the TiO₂, optionally the separating is carried out by selectively solubilizing the Sb₂O₃ in a basic medium, optionally the basic medium comprises an aqueous hydroxide solution (e.g. KOH. NaOH, LiOH).

In some embodiments, the flame retardant further comprises organic flame retardant.

In some embodiments, the organic flame retardant is selected from PBDE, TBBPA, TBPC, and mixtures thereof.

In some embodiments, the organic flame retardant is selected from DBDPE, N, N-ethylene bis(tetrabromophthalimide), Tris(tribromoneopentyl)phosphate and mixtures thereof.

In some embodiments, the method further comprises separating the inorganic flame retardant from the organic flame retardant.

In some embodiments, the method further comprises purifying the recovered flame retardant.

In some embodiments, the styrenic polymer is selected from ABS, HIPS, atactic polystyrene (PS), SAN, SBS, syndiotactic PS, isotactic PS, Styrene Methyl Methacrylate (SMMA), Methyl methacrylate-acrylonitrile-butadiene-styrene (MABS), Methyl methacrylate-butadiene-styrene (MBS), and mixtures thereof.

In some embodiments, the styrenic polymer is derived from styrene-based monomer or vinyl aromatic monomer copolymerized with one or more polymerizable monomers. For example, the one or more polymerization monomers can be unsaturated nitriles. Unsaturated nitrile can include but is not limited to, acrylonitrile, methacrylonitrile, ethacrylonitrile, fumaronitrile, and mixtures thereof.

In some embodiments, the styrenic polymer can be crosslinked and/or grafted with one or more other polymers. The one or more other polymers can include polymerized conjugated alkenes. For example, the conjugated alkenes can include dienes such as 1,3-butadiene, 2-methyl-1,3-butadiene (isoprene), 2-methyl-1,3-pentadiene, and other such dienes, and mixtures thereof. In some embodiments, the conjugated alkene is 1,3-butadiene, isoprene, or mixtures thereof.

In some embodiments, the styrenic polymer is selected from acrylonitrile-butadiene styrene (ABS), high impact polystyrene (HIPS), styrene acrylonitrile copolymer (SAN), styrene butadiene styrene copolymer (SBS), and mixtures thereof.

In some instances, it can be appreciated by a skilled person that it may be useful to select a styrenic polymer non-solvent having a boiling point that is around or slightly above the glass transition state temperature (Tg) to soften the gel formed by a styrenic polymer swollen by solvent. For example, it may be desirable to heat a gel or microgel comprising a styrenic polymer and a styrenic polymer non-solvent close to the Tg of the styrenic polymer gel or microgel to facilitate removal of soluble flame retardants by washing the gel or microgel with further portions of the styrenic polymer non-solvent at or close to the boiling point of the non-solvent.

In some embodiments, the styrenic polymer non-solvent is selected from C₅₋₈ alkanes, C₁₋₆ alkyl alcohols, and mixtures thereof. It can be appreciated that a suitable non-solvent can be selected for a specific styrenic polymer of interest through means known in the art.

In some embodiments, the flame retardant non-solvent is selected from C₅₋₈ alkanes, C₁₋₆ alkyl alcohols, and mixtures thereof. It can be appreciated that a suitable non-solvent can be selected for a specific flame retardant of interest through means known in the art. For example, if the nature of flame retardant present in a styrenic polymer waste is known or determined, a specific non-solvent can be selected accordingly.

In some embodiments, the recovered flame retardant is reused in the manufacture of polymer material. For example, the polymer material can comprise styrenic polymer or non-styrenic polymer. For example, the polymer material can comprise thermoplastic and/or thermoset plastic. For example, the polymer material can comprise polyolefin (e.g. polyethylene, polypropylene), polycarbonate, epoxy, polyester, polyamide, or mixtures or copolymers thereof.

In some embodiments, the styrenic polymer waste further comprises an inorganic pigment such as TiO₂. The inorganic pigment has similar non-soluble character as inorganic flame retardants as described herein. As such, the inorganic pigment can be recovered together from the styrenic polymer waste with any inorganic flame retardant. Once the inorganic pigment and the inorganic flame retardant have been recovered, the two can be separated using methods known in the art. For example, some inorganic compounds can be selectively solubilized or precipitated in acid or basic medium. Thus, acid or base can be added to the recovered inorganic compounds to selectively solubilize certain compounds. For instance, Sb₂O₃ is known to be soluble in basic medium, whereas TiO₂ is not. A mixture of Sb₂O₃ and TiO₂ recovered from a styrenic polymer waste can be separated from each other by selectively solubilizing Sb₂O₃ in basic medium (e.g. by adding an aqueous hydroxide solution) and filtering the solid TiO₂. Both the inorganic pigments and the inorganic flame retardants can be repurposed for example in the manufacture of other polymer material.

In some embodiments, the purifying of the recovered flame retardant comprises selective precipitation, recrystallisation, column chromatography (e.g. silica column) or combinations thereof.

### EXAMPLES

The following non-limiting examples are illustrative of the present disclosure.

### General Methods

All solvents are chromatography grade with a high purity and purchased from Sigma Aldrich. The flame retardants were also purchased from Sigma Aldrich or a specialist provider of flame retardants. The X-ray fluorescence spectrophotometer used was a Bruker Titan S1.

### Example 1 Solubility Test of Flame Retardants in Different Solvents

A number of common flame retardants have been tested for their solubility in various solvents. A 2 wt % solution of each flame retardant was made in different solvents at room temperature. The solubility result is shown in Table 1.

TABLE 1
Solubility of flame retardants

| | Solvent | | | | |
|---|---|---|---|---|---|
| | Ethyl | | | Methylethyl | |
| Flame retardant | aetate | heptane | p-cymene | ketone | toluene |
| Antimony(III) oxide | insoluble | insoluble | insoluble | insoluble | insoluble |
| DBDPE | insoluble | insoluble | insoluble | insoluble | insoluble |
| (1,2-Bis(pentabromophenyl) | | | | | |
| ethane) | | | | | |
| N,N-ethylene | insoluble | insoluble | insoluble | insoluble | insoluble |
| bis(tetrabromophthalimide) | | | | | |
| PBDE/Methyl Octabromo Ether | soluble | insoluble | soluble | soluble | soluble |
| tbba bis/brominated epoxy | insoluble | insoluble | Partially | Mostly | Mostly |
| oligomer; brominated epoxy | | | soluble | soluble | soluble |
| polymer | | | (cloudy | | |
| | | | solution) | | |
| TBBPA/3,3′,5,5′- | soluble | insoluble | soluble | soluble | soluble |
| Tetrabromobisphenol A | | | | | |
| TBPC/2,4,6-Tris(2,4,6- | soluble | insoluble | soluble | soluble | soluble |
| tribromophenoxy)-1,3,5-triazine | | | | | |
| Tetrabromobisphenol S Bis-(2,3- | Partially | insoluble | Partially | Mostly | Partially |
| Dibromopropyl) Ether | soluble | | soluble | soluble | soluble |
| | (cloudy | | (cloudy | | (cloudy |
| | solution) | | solution) | | solution) |
| Tris(tribromoneopentyl)phosphate | insoluble | insoluble | insoluble | insoluble | Mostly |
| | | | | | insoluble |

It is expected that flame retardants that are not completely soluble in a given solvent (e.g. partially soluble or mostly soluble) can be substantially solubilized by increasing temperature of the solution.

### Example 2 Recovery of Brominated Flame Retardant and Inorganic Flame Retardant from ABS

Model styrenic polymer waste materials were made with ABS pellets and different brominated flame retardants. Mixture A was made with 10 g of ABS pellets and 1 g 3,3′,5,5′-Tetrabromobisphenol A (TBBPA) in 90 g ethyl aetate. Mixture B was made with 10 g ABS pellets, 1 g NN-Ethylene-bis(tetrabromophthalimide) in 90 g ethyl acetate.

Both mixtures were vigorously stirred for five hours at room temperature. The resulting mixture was centrifuged at 8500 rpm for 20 minutes. Using X-ray fluorescence, the bromine content of the supernatants were assessed. The results are shown in Table 2.

TABLE 2
Br content of the supernatants

| XRF (ppm) | Br |
|---|---|
| Mixture A | 6402 ± 44 |
| Mixture B | 7131 ± 47 |
| Mixture A | 6623 ± 45 |
| after | |
| centrifuge | |
| (supernatant) | |
| Mixture B | 38 ± 3 |
| after | |
| centrifuge | |
| (supernatant) | |

As shown in Table 2, NN-Ethylene-bis(tetrabromophthalimide) is not soluble in ethyl acetate and was removed by centrifugation of the mixture.

The centrifugation residue from Mixture B is analysed to show that it contains NN-Ethylene-bis(tetrabromophthalimide) as well as some microgel containing polybutadiene (PBu). This residue is washed by 50 g ethyl acetate twice to further remove soluble ABS portions. The washed residue is dried at 100° C. for two hours. The dried residue contains NN-Ethylene-bis(tetrabromophthalimide), which can be repurposed.

Alternatively, the residue from Mixture B containing NN-Ethylene-bis(tetrabromophthalimide) and the PBu and/or copolymer of PBu microgel is dispersed in 100 g of toluene, or a good PbU and/or copolymer of PBu swelling agent. The resulting mixture heated to 60° C. for five hours with stirring. The resulting mixture is centrifuged at 3000 rpm for five minutes. The microgel containing the PBu moieties remains in suspension in the supernatant while the NN-Ethylene-bis(tetrabromophthalimide) deposits at the bottom as a pellet. The polymer PBu and the NN-Ethylene-bis(tetrabromophthalimide) are separated and each can be repurposed.

As shown in Table 2, TBBPA was soluble in ethyl acetate and remained in the supernatant portion of the centrifuged Mixture A, where the ABS was also soluble.

The supernatant of Mixture A is combined with 60 g of a styrenic polymer non-solvent (e.g. heptane or methanol) to create a paste. The combining is done at room temperature or a suitable temperature to maintain the polymer paste above its glass transition temperature (Tg). The supernatant solvent is recovered as fraction 1. The paste is then washed twice with a mix of ethyl acetate and the non-solvent (e.g. heptane or methanol) at a temperature and solvent ratio to maintain the polymer in a paste form above its Tg. Each wash portion is retained as fraction 2 and fraction 3 respectively. Fractions 1 to 3 are combined, and the solvent is evaporated to recover TBBPA. The dried TBBPA is further purified by dissolving the remaining trace of polymer in a solvent for styrenic polymer such as p-cymene or a mixture of styrenic polymer solvent and styrenic polymer non-solvent (e.g. mixture of p-cymene and heptane) and where the TBBPA is not soluble. Any remaining polymer in the recovered TBBPA dissolves in the solvent. The solution is filtered to remove the soluble portion containing polymer (e.g. ABS, SAN and small chain impurities). The residue is washed with fresh portion of the same solvent and dried to obtain purified TBBPA. The purified TBBPA can be further purified by for example recrystallisation.

### Example 3 Recovery of Inorganic Flame Retardants from Post-Consumer HIPS

30 g of post-consumer HIPS waste was dissolved in p-cymene to make a solution containing 15 wt % in HIPS waste. To this solution, about 10 wt % of methanol was added. The resulting mixture was centrifuged at 8500 rpm for 20 min. The supernatant was recovered. 340 g of heptane was added to the supernatant to precipitate the polymer content. The precipitate was removed as a paste and washed at a temperature higher than its Tg. The content of various inorganic metals and bromine in the recovered polymer and the HIPS waste was assessed by X-Ray fluorescence. The results are shown in Table 3.

TABLE 3
Inorganic metal and Br content

| XRF (ppm) | Br | Sb | Zn | Cu | Ni | Fe | Cr |
|---|---|---|---|---|---|---|---|
| HIPS | 109K ± | 56K ± | 159 ± | 60 ± | 72 ± | 299 ± | 124 ± |
| waste | 521 | 536 | 24 | 22 | 24 | 58 | 53 |
| Polymer | 176 | — | — | — | — | — | — |
| recovered | | | | | | | |

As seen in Table 3, most of the inorganic additives were removed as insolubles. The recovered polymer had mostly no detectable level of inorganic flame retardants.

The residue from the centrifugation contained Sb and Br and some microgel containing polymer. The residue was washed with a styrenic polymer solvent p-cymene to remove the remaining HIPS. The remaining insoluble portion contained the flame retardant and some microgel.

The remaining insoluble portion was dispersed in hot toluene, or a good PbU and/or copolymer of PBu swelling agent, and centrifuged. The microgel containing any remaining polymer remained as a suspension, while the flame retardant deposited at the bottom as a pellet. The polymer and the flame retardant (e.g. Sb) were then separated. Each component can be repurposed accordingly.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1-17. (canceled)

18. Method of recovering a flame retardant from a styrenic polymer waste, the styrenic polymer comprising the flame retardant and a styrenic polymer, the method comprising
combining the styrenic polymer waste with a first solvent to obtain a soluble portion and an insoluble portion, and
separating the soluble portion and the insoluble portion,
wherein the flame retardant is substantially in the insoluble portion and the styrenic polymer is substantially in the soluble portion.

19. The method of claim 18, further comprising drying the insoluble portion to recover the flame retardant.

20. The method of claim 19, further comprising washing the insoluble portion with one or more further portions of the first solvent to obtain a wash portion and a washed insoluble portion.

21. The method of claim 20, further comprising drying the washed insoluble portion to recover the flame retardant.

22. The method of claim 18, further comprising recovering the styrenic polymer by solvent removal, optionally the solvent removal comprises solvent evaporation, precipitation, and/or crystallisation.

23. The method of claim 18, wherein the first solvent is selected from C₅₋₈ alkanes, C₁₋₅ alkyl alcohol, and mixtures thereof, optionally the first solvent is selected from pentane, hexane, heptane, octane, methanol, ethanol, propanol, isopropanol, butanol, and mixtures thereof.

24. The method of claim 18, wherein the flame retardant is selected from DBDPE, N,N-ethylene bis(tetrabromophthalimide), Tris(tribromoneopentyl)phosphate and mixtures thereof.

25. The method of claim 18, wherein the flame retardant comprises inorganic flame retardant, optionally the inorganic flame retardant being selected from Sb₂O₃, ammonium halide, metal hydroxides, Ca₃(BO₃)₂, inorganic nitrate salts, inorganic phosphate salts, inorganic phosphonate salts, and mixtures thereof.

26. The method of claim 25,
wherein the method further comprises prior to the separating of the soluble portion and the insoluble portion, combining the soluble portion and the insoluble portion with a second solvent to obtain a microgel comprising a portion of the styrenic polymer in the soluble portion; and
wherein the separating of the soluble portion and the insoluble portion is carried out by centrifugation such that the microgel of the styrenic polymer is present as a suspension in the soluble portion and the insoluble portion is present as a pellet, and
optionally wherein the second solvent is capable of swelling the styrenic polymer or forming a gel with the styrenic polymer,
optionally wherein the second solvent is selected from p-cymene, toluene, benzene, ethylbenzene, ethyl acetate, acetone, MEK, and mixtures thereof.

27. The method of claim 26, wherein the microgel comprises about 15 wt % to about 25 wt % of the styrenic polymer.

28. The method of claim 26, further comprising recovering the pellet to recover the flame retardant, and optionally washing the pellet with one or more further portions of the first solvent.

29. The method of claim 25, wherein the inorganic flame retardant comprises Sb₂O₃.

30. The method of claim 29, wherein the styrenic polymer waste further comprises an inorganic pigment, optionally the inorganic pigment comprises TiO₂, wherein the inorganic pigment is recovered with the inorganic flame retardant, and optionally wherein the method further comprises separating the Sb₂O₃ and the TiO₂, optionally the separating is carried out by selectively solubilizing the Sb₂O₃ in a basic medium, optionally the basic medium comprises an aqueous hydroxide solution.

31. The method of claim 30, wherein the aqueous hydroxide solution is selected from KOH, NaOH, LiOH and mixtures thereof.

32. The method of claim 25, wherein the flame retardant further comprises organic flame retardant.

33. The method of claim 32, wherein the organic flame retardant is selected from PBDE, TBBPA, TBPC, and mixtures thereof.

34. The method of claim 32, wherein the organic flame retardant is selected from DBDPE, N,N-ethylene bis(tetrabromophthalimide), Tris(tribromoneopentyl)phosphate and mixtures thereof.

35. The method of claim 32, further comprising separating the inorganic flame retardant from the organic flame retardant.

36. The method of claim 18, further comprising purifying the recovered flame retardant.

37. The method of claim 18, wherein the styrenic polymer is selected from ABS, HIPS, atactic polystyrene (PS), SAN, SBS, syndiotactic PS, isotactic PS, Styrene Methyl Methacrylate (SMMA), Methyl methacrylate-acrylonitrile-butadiene-styrene (MABS), Methyl methacrylate-butadiene-styrene (MBS), and mixtures thereof.

38. The method of claim 26, wherein the styrenic polymer is selected from HIPS, ABS, and mixtures thereof.

39. The method of claim 38, wherein the gel comprises polybutadiene components of the styrenic polymer.
